(19) United States
(12) Patent Application Publication
(10) Pub. No.: US 2004/0071316 A1
(43) Pub. Date: Apr. 15, 2004

(54) Method for image recognition in motor vehicles

(76) Inventors: Fridtjof Stein, Ostfildern (DE); Alexander Wuerz-Wessel, Tuebingen (DE)

Correspondence Address: DAVIDSON, DAVIDSON & KAPPEL, LLC, 485 SEVENTH AVENUE, 14TH FLOOR, NEW YORK, NY, 10018, US

(21) Appl. No.: 10/470,458

(22) PCT Filed: Jan. 5, 2002
(86) PCT No.: PCT/EP02/00056

(30) Foreign Application Priority Data
Jan. 30, 2001 (DE) 101-03-870.4

(51) Int. Cl. G06K 9/00

(52) U.S. Cl. 382/103; 382/170

(57) ABSTRACT

The invention relates to a method for image recognition in motor vehicles, whereby electromagnetic waves emanating from an object are detected by at least one sensor with regard to the direction and intensity thereof, evaluated and transferred to an image matrix. The untouched original image of the object and additional reflected waves from the object, reflected at the chassis, called the mirror image below, is recorded by the sensor. The mirror image and the original image are then taken for evaluation, whereby, firstly, the position and geometry of the reflecting surfaces of the chassis relative to the sensor are determined.

The invention relates to a method for image identification on the basis of stereo image processing, in which electromagnetic waves which originate from an object are received by at least one sensor both with regard to their intensity and with regard to their direction, are evaluated and are transferred to an image matrix, as is used in industry and in particular in the automobile industry.

A method and an apparatus for measuring distance to objects is known from the article by Nayer S. K., 1988, Sphereo: Determining Depth using Two Specular Spheres and a Single Camera, In Proceedings of SPIE: Optics, Illumination, and Image Sensing for Machine Vision III, Vol. 1005., SPIE, Society of Photo-Optical Engineering, 245-254, in which a camera records the original image of an object as well as two mirror images of the object, which are reflected on two reflective surfaces. The distance to the object can then be determined using these three images, with the assistance of a mathematical algorithm. In this method, it is essential for the reflective surfaces to have a specific geometry. It is also essential for the physical position and orientation of the reflective surfaces to be known and to always remain the same, both with respect to their distance and their angle with respect to the camera and with respect to one another. An apparatus such as this and hence the associated method are in any case suitable only to a limited extent for use in a motor vehicle and, in this case, in particular in an automobile.

Furthermore, in particular in the field of computers and robotics, a method (stereo image processing) is known, in which the distance to an object is determined with the assistance of two cameras. In this case, the base line, that is to say the distance between the cameras, affects the measurement accuracy. From this viewpoint, it would be desirable to use a base line that is as long as possible, although this is possible only within tight limits in a vehicle. Furthermore, in order to make it possible to determine the distance to the object, the object must be identified uniquely in the left image and in the right image. The probability of this correspondence being found correctly is referred to as matching and decreases as the base line lengthens and hence as the difference in the viewing angle lengthens. A tradeoff must therefore be made between measurement accuracy and matching probability.

Furthermore, problems with repetitive patterns occur with two-camera stereo. Slatted fences, single trees or terrains, particularly when parts of the pattern are concealed from one camera by other objects, lead to incorrect matching and thus to incorrect object distances, when using two cameras. Concealment is caused by widely different objects. For example, for use in a motor vehicle, this may be an approaching vehicle or else the windshield wiper, which is instantaneously obscuring the view on one camera.

The object of the invention is to provide a method for distance measurement in which at least some of the disadvantages that have been mentioned are reduced, in particular overcome, with costs which are as low as possible.

The object is achieved by a method having the method steps in claim 1. The advantageous characteristics and methods of operation of the subject matter of the invention will be explained in detail in the context of the method being used according to the invention, by way of example, in a motor vehicle. Since, in particular, an engine hood with high-quality paintwork can effectively be regarded as a mirror on motor vehicles, it is possible to consider the reflection of an object on the engine hood as a reference. The effect can in this case be compared with the use of a further camera, which is pointing directly from a different viewing angle at objects which can be observed directly. The mirror images can be associated directly with the objects to be considered. These reflections can be reconstructed with the correct perspective by means of mathematical algorithms which are also known, in particular, from astronomy. It is thus possible without any further hardware complexity to minimize or to eliminate problems with stereo cameras, in particular, just by model-based calculations. With a suitable configuration, stereo image processing can be carried out with one camera, in order to assist other problems that occur in single camera applications. The reconstruction capabilities are restricted, for example, by dirt on the engine hood. However, if the image quality allows the processing to be carried out, the problems of stereo image processing can be solved since a stereo calculation can then also be carried out using one camera, and a solution for selective matching hypothesis choice for repetitive patterns is possible. However, the images from the engine hood reflection cannot be reconstructed completely, but only locally in a perspective form. Complete reconstruction is possible only if the engine hood has a surface similar to a spherical section. A surface such as this can be approximated locally. Despite this restriction, the extension to the functionality of object association according to the invention allows the reliability of distance determination to be improved considerably.

Further worthwhile refinements can be found in the dependent claims. In addition, the invention will be explained on the basis of an exemplary embodiment which is illustrated in the drawings, in which:

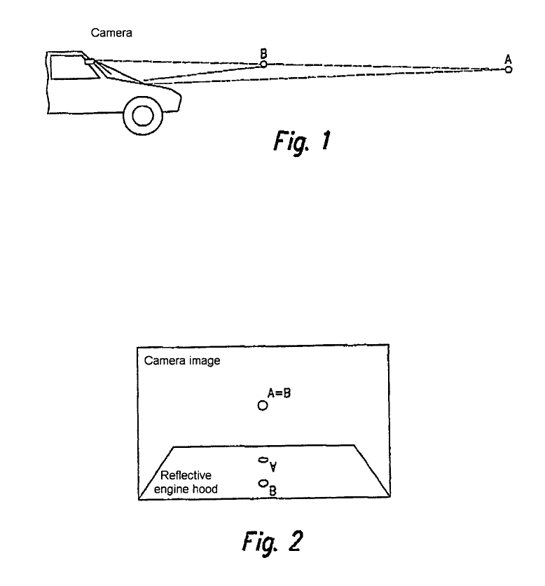

FIG. 1 shows a side view with a schematic illustration of a beam path, and

FIG. 2 shows a reflected image of the beam path shown in FIG. 1, on an engine hood.

FIG. 1 shows a side view with a schematic illustration of a beam path, such as that which occurred when using a method according to the invention for a vehicle in an eye of a camera, in particular in a stereo camera. The points B and A describe two objects, with the object A being at least partially concealed by the object B; that is to say the original image of the lightwave from A lies along the same line as the beam with respect to the viewing camera. Since the position and orientation of the camera with respect to the engine hood are fixed, this results, however, in different locations for the mirror images of the objects A and B as can be observed by this camera. If the geometry of the engine hood is known, the at least generally distorted mirror image B′ can be identified for example by modified image comparison with the object B. This identification process in turn makes it possible to separate the object A from the object B which is at least partially concealed by it, by means of measurement techniques. This separation capability and the knowledge of the distance between the camera and the mirror images A′ and B′ as well as their angular position and orientation with respect to the camera also make it possible to calculate the distance between A and B.

As already mentioned, it is worthwhile using methods for representing distorted images for the image processing. One method, in which image distortion is used deliberately, is, for example, an anamorphosis in the corrective optics, and the film technique. Each optical system with different values in the two main sections is referred to as being anamophotic. This is generally used to correct astigmatism, when the error exists on only one meridian.

A number of methods can be used for reconstruction of the images, some of which are described here. It is expedient to make a number of assumptions for the reconstruction of the images, and these are described in the following text.

1. The engine hood is a specular reflector.

It is possible to distinguish between specular and diffuse components in the reflection. For modeling of computer graphics or determining the shape from the shadow that is thrown, the directional distribution of the reflected radiation depends on the relative positions of the observer, the surface and the light source. This distribution is described by what is referred to as a BRDF model (Bi-directional Reflectance Distribution Function). These functions have been developed for various reflection models. Since the smooth, gloss-painted engine hood is one of the best painted parts on an automobile, and has roughness levels only in the micrometer range, it can be regarded as a specular reflector. This situation allows the imaging to be carried out by the beam optics.

2. The camera is a perspective pinhole camera.

The technical arrangement and the cameras that are used allow perspective imaging to be carried out. In reality, a pinhole camera should expediently not be used, owing to the light attenuation. However, the lens errors can be corrected in order to regard the system that is used as a pinhole camera.

3. The image is reconstructed on one plane.

This is the reconstruction surface, which corresponds to a correct human perspective, and which is associated with the pinhole camera model that is used.

4. There are no objects in the area between the mirror and the camera.

If any objects are located in this area, then these would need to be identified from reflections by appropriate image processing steps. As has been found in the context of the intended use and in order to solve the problem, it is advantageously possible to assume that only reflections can be seen in the corresponding image area.

5. The reconstruction is restricted to the central, concave area of the engine hood.

Since the strongest distortion occurs in the convex areas of the engine hood, the reconstruction in these areas is highly complex. Only the front of the vehicle and the concave central area of the engine hood are thus used for reconstruction. Owing to the camera position, which is preferably arranged in the area of the internal rear-view mirror, this area also contains the directions which are most important for the reconstruction process using the method according to the invention. In addition, this surface corresponds in the CAD data to a surface element and is not an assembly.

6. The configuration will not change.

The expression a steady configuration means that the geometric characteristics are constant. No changes occur in the hood geometry and the relative position of the first models. This assumption is ignored in the context of camera calibration and, especially, for adaptive camera calibration.

It is also advantageous for reconstruction for the geometric data such as the incidence points of the reflected beam on the engine hood and normal vectors at these points to be known. These could originate either from CAD data or from corresponding calibration methods, which will be described later.

One possible way to reconstruct the image is to image a known pattern, and to compare the reflection with the original. For this purpose, the reflection of a calibration wall which is positioned vertically in front of the automobile in the engine hood is simulated. In this case, the distortion of the square structure can be observed well. The corresponding points on the image plane and on the mirror plane are now looked for. This results in a two-dimensional field with displacement vectors.

For stereo image processing, it is necessary to obtain images on a different viewing angle. However, if the mirror image is corrected using the area which can be seen directly, then it is precisely this additional information which is lost in this process. In this case, the mirror image must be corrected for the view of a virtual camera such as this. The extrinsic parameters of this virtual camera are, however, therefore not known.

If other methods are used in order to calculate this camera, then the solution to the reconstruction task is complete, and this two-dimensional image-based correction method is obsolete.

The above procedures essentially have the aim of finding the position and viewing direction of a virtual camera for image reconstruction. Once these extrinsic camera parameters for the virtual camera have been found, the mirror image can be reconstructed with the aid of the hood geometry. In order to make it possible to determine these external parameters for the virtual camera accurately, it is first of all necessary to know the external parameters of the actual camera.

The effects of different camera positions on any measurement error, in particular, are considerable. Various methods are therefore proposed in the following sections which could be used for determining the position and viewing direction of the actual camera relative to the engine hood. These methods may advantageously even in some cases also allow determination of the geometric characteristics of the surface, so that there is no need to use CAD data. The intrinsic camera parameters of the virtual camera may, in contrast, be chosen freely.

The internal parameters of the real camera are adopted, in order to simplify the further processing in the multiocular system.

Strip projection is one method for measuring three-dimensional surfaces. This makes use of a specific configuration, in which the relative positions of the strip projector and of the camera are known precisely. A sequence of different strip patterns is then projected onto the object, and is recorded by the camera. The strips pass through the object in planes, and the section plane can be calculated by determining the position of the known strip in the camera image. Accuracy in the submillimeter range can be achieved with an appropriate measurement duration and with the object being at an appropriate distance from the measurement layout. This data can be approximated by triangulation, so that the surface is known mathematically, and the incidence points and normal vectors can be calculated.

The use of a CCD, and/or of a CMOS, or some other suitable camera for recording the image results in digitization, so that corresponding digitization of the surface could be sufficient. Once again, the calculation can be improved by associating image areas with objects. In the method which is now proposed and which is based on what is referred to as the laser guide star method, two recordings of a calibration wall are used. Since both the incidence point and the reflection direction and/or the normal vector must be determined at that point, more than one recording is required. For each pixel in the area of the engine hood (z0), the corresponding pixel is looked for (z) in the direct viewing area of the corresponding object. After shifting the wall, the same pixel z0 is used, and the corresponding pixel z0, which has now been shifted, is looked for. Since the geometry of and the distance to the calibration wall (a, a0, x, x0) are known, the incidence point (xp, zp) can be calculated. There is no longer any need to determine the normal vector, since the reflection direction can be calculated directly in three-dimensional space from the incidence point and x, a and/or x0, a0.

This method completely avoids the need for CAD data or other data sources, which would need to be used as a function of this. In addition to the calibration, this approach also provides the geometric information which is required to calculate the object distances.

The described solution approaches are aimed in various directions, in each of which different problems need to be solved. However, the camera calibration, that is to say the determination of the position and viewing direction relative to the engine hood, is always important.

If a reconstruction of the image is carried out in the normal sense, then the choice of the viewing point and the viewing direction is important. Since only rotated conical sections in conjunction with an appropriate camera produce a catadioptric system with a single viewing point, errors will always occur during reconstruction with a chosen viewing point. The viewing direction is in this case reflected in the choice of the reconstruction plane, as the plane at right angles to the viewing direction. Even the choice of the distance to this reconstruction plane is significant in this approach, which is subject to errors. Thus, if a reconstruction such as this is used, extensive error analyses are required.

If use is made of the approach in which the object identification is first of all carried out in suitable search windows and a triangulation process is then carried out for the corresponding pixels, the distance accuracy to be expected is considerably better since, in this sense, no reconstruction errors occur.

In order to carry out a sensible reconstruction of the images reflected on the engine hood, the epipolars of the reflective surface of the bodywork have previously been determined in an expedient manner.

An epipolar is defined as follows: a viewing beam S0 passes through the focal point F0 of a camera KO and a point P0 in the imaging plane of the camera K0. The focal point of a further camera K1, which is not at the same location as K0, has the focal point F1. The epipolar plane which is defined by the viewing beam S0 and the focal point F1 intersects the image plane of the camera 1 along the epipolar curve L1. For a pinhole camera, the epipolar L1 is a line.

Reflections from calibration objects with a known geometry and which are at a known distance from the engine hood are recorded in order to determine the epipolars. The epipolars are determined from these (calibration) reflections and a calibration function is produced, and this is used later for evaluation.

The invention is not, of course, restricted to use in a motor vehicle, but can be extended in an obvious manner to other application fields and objects, in which reflective surfaces are present.

1. A method for image identification on the basis of stereo image processing, in which electromagnetic waves which originate from an object are received by at least one sensor both with regard to their intensity and with regard to their direction, are evaluated and are transferred to an image matrix,
characterized
in that the position, orientation and geometry of a reflective surface with respect to the sensor is determined,
in that the undisturbed original image of the object is received by the sensor,
in that, in addition, reflected waves from the object, which are reflected from the reflective surface, referred to in the following text as the mirror image, are received, and
in that the mirror image and the original image are used for evaluation.

2. The method as claimed in claim 1,
characterized
in that the epipolars of the reflective surface are determined,
in that the reflections on the epipolars are received using calibration objects with a known geometry and at a known distance, and
in that a calibration function is produced from this,
in that the calibration function is used for evaluation.

3. The method as claimed in claim 2,
characterized
in that the position of the mirror image with respect to the epipolars is determined, and in that the position of the mirror image is used to determine the distance to the object.

4. The method as claimed in claim 1,
characterized
in that a stereo camera, in particular a stereo CCD camera, is chosen as the sensor.

5. The method as claimed in claim 1,
characterized
in that a camera is chosen as the sensor, and in that the original image of the object as well as the reflection on the reflective surface are recorded using a camera, and the reflection on a reflective surface with a known geometry, preferably on a sphere, which is arranged at a known distance from the camera is recorded as a reference image by the camera.

6. The method as claimed in claim 1,
characterized
in that the original image of an object is determined and evaluated separately from the mirror image of the object, and in that corresponding image points and/or details are determined between the complete processed original image and the correspondingly processed mirror image.

7. The method as claimed in claim 1,
characterized
in that triangulation is carried out by means of corresponding image points and/or surfaces in order to determine the distance to the object.

8. The method as claimed in claim 1,
characterized
in that triangulation is carried out by means of corresponding image points and/or surfaces in order to determine the angle to the object.

9. The method as claimed in claim 1,
characterized
in that triangulation is carried out by means of corresponding image points and/or surfaces in order to determine the location of the object.

10. The method as claimed in claim 1,
characterized
in that the measurement range of the electromagnetic waves is chosen from the ultraviolet to the FIR, in particular between the ultraviolet and the FIR.

11. The use of the method as claimed in one of patent claims 1 to 10 in a motor vehicle.

12. Use as claimed in claim 11,
characterized
in that the reflective surface is formed by a part of the bodywork,.
